(19) United States
(12) Patent Application Publication
(10) Pub. No.: US 2026/0003035 A1
(43) Pub. Date: Jan. 1, 2026

(54) METHOD FOR FOCUSING THE RADAR DETECTION FOR A RELATIVE MOVEMENT

(71) Applicant: Continental Autonomous Mobility Germany GmbH, Ingolstadt (DE)

(72) Inventor: Markus Wintermantel, Lindau (DE)

(73) Assignee: Continental Autonomous Mobility Germany GmbH, Ingolstadt (DE)

(21) Appl. No.: 19/113,784

(22) PCT Filed: Sep. 7, 2023
(86) PCT No.: PCT/DE2023/200179

§ 371 Date: Mar. 20, 2025

(30) Foreign Application Priority Data
Sep. 20, 2022 (DE) 10 2022 209 859.5

(51) Int. Cl. G01S 7/35; G01S 13/34; G01S 13/58; G01S 13/931

(52) U.S. Cl. CPC G01S 7/356; G01S 7/354; G01S 13/343; G01S 13/584; G01S 13/931; G01S 2013/93185

(57) ABSTRACT

A method for detecting the environment of a vehicle with a radar system comprises modulating the frequency of emitted transmission signals to include a sequence of frequency ramps. A signal with a current transmission frequency is mixed with transmission signals reflected by objects. An output signal of the mixture is scanned during each of the frequency ramps. After preprocessing a two-dimensional discrete time-frequency transformation over the scanning values is determined. Dependent on the vehicle movement, the preprocessing of the scanning values includes a frequency shift of the signal formed from the scanning values such that the frequency of the signals formed by the scanning values respectively remains unchanged over the frequency ramps for objects with a defined radial relative movement. Thus, fuzziness of power peaks generated by such objects is counteracted in the two-dimensional time-frequency transformation.

### TECHNICAL FIELD

A radar system for deployment in driver assistance systems in a motor vehicle and a method for focusing radar detection for a relative movement is disclosed.

### BACKGROUND

Motor vehicles are increasingly being equipped with driver assistance systems which detect the surroundings or the respective traffic situation with the aid of sensor systems and derive automatic reactions of the vehicle and/or instruct, in particular warn, the driver from the thus recognized traffic situation. Here, a distinction is made between comfort and safety functions.

As a comfort function, FSRA (Full Speed Range Adaptive Cruise Control) plays an important role in the current development. The vehicle adjusts the ego speed to the desired speed predefined by the driver, provided the traffic situation permits this, otherwise the ego speed is automatically adapted to the traffic situation.

Safety functions now exist in many and diverse forms. One group is made up of functions for reducing the braking or stopping distance in emergency situations up to autonomous emergency braking. A further group is made up of lane change functions: they warn the driver or take over the steering if the driver would like to perform a hazardous lane change, that is to say if a vehicle is either located in the blind spot on the adjacent lane (which is referred to as BSD—“Blind Spot Detection”) or is rapidly approaching from behind (LCA—“Lane Change Assist”).

The driver is now no longer only assisted, but rather the job of the driver is increasingly being dealt with autonomously by the vehicle, i.e., the driver is increasingly being replaced; this phenomenon is known as autonomous driving.

Radar sensors are deployed, including frequently in fusion with other technology's sensors such as, e.g., camera sensors, for systems of the type described above. Radar sensors, inter alia, work reliably, even in poor weather conditions, and, in addition to the spacing of objects, they can also directly measure the radial relative speed thereof by means of the Doppler effect. As a general rule, 24 GHz, 77 GHz and 79 GHz are deployed as transmission frequencies.

In addition to a high sensor range, the aforementioned functions require high measurement accuracy, resolution and separation capability for distance and relative speed. Thus, high resolution and separation capability for distance and relative speed are also important because the poor angular resolution and separation capability of motor vehicle radar sensors (resulting from their small size) can at least be partially offset as a result. However, there is the problem in today's radar systems that a simultaneous high resolution of distance and relative speed is only fully possible in the case of a comparatively small relative movement between the object to be measured and the radar system. At higher relative speeds, “blurring” or “fuzziness” can occur in the radar detection. The term “blurring” or “fuzziness” can for example be understood to mean that, e.g., point-shaped objects in the radar image expand into multiple detection cells and, consequently, appear as extended objects.

### SUMMARY

The object is to be able to simultaneously realize a high distance and relative speed resolution with a motor vehicle radar sensor for relatively moving objects. For example, stationary objects are of interest for sensors looking in the direction of travel.

In the case of the method for a radar system for detecting the environment of a motor vehicle, the radar system comprises transmission means for emitting transmission signals, reception means for receiving transmission signals reflected by objects, and signal processing means for processing the received signals, wherein the frequency of the emitted transmission signals is modulated such that it includes a sequence of K linear ramps with at least approximately the same gradient and duration, hereinafter referred to as frequency ramps. In the signal processing means, a signal with substantially the current transmission frequency or a constant offset thereto is mixed with the transmission signals reflected by objects and received by the reception means. Furthermore, in the signal processing means, the output signal of the mixture is, if necessary after suitable preprocessing (e.g., amplification, bandpass filtering or the like), scanned I times during each of the K frequency ramps and, in the signal processing means, after preprocessing, a two-dimensional discrete time-frequency transformation over these I·K scanning values is completely or only partially determined, wherein, preferably dependent on the vehicle movement, the preprocessing of the I·K scanning values includes a frequency shift of the signal formed from the I scanning values of the respective frequency ramp such that the frequency of the signals formed by the I scanning values respectively remains unchanged over the K frequency ramps for objects with a defined radial relative movement, as a result of which blurring or fuzziness of the power peaks generated by such objects is counteracted in the two-dimensional time-frequency transformation.

The method can be used for a radar system, the detection range of which includes the direction of travel, wherein the defined radial relative movement is the negative of the vehicle's ego movement, so that the frequency of the signals formed by the I scanning values respectively remains constant over the K frequency ramps for stationary objects in the direction of travel.

Furthermore, in the case of the method, the frequency shift can be realized by multiplication by a rotating complex unit vector.

The frequency shift may be realized by multiplication by a rotating complex unit vector, wherein the I scanning values respectively of the frequency ramps are equidistant in time and the rotation speed of the complex unit vector is constant during each frequency ramp, but changes over the frequency ramps.

According to a configuration, the rotation speed of the complex unit vector can change over the frequency ramps proportionally to the integral of the speed of the defined radial relative movement, that is to say, for example proportionally to the integral of the vehicle's ego speed.

The center frequency and time interval of the frequency ramps may be at least approximately constant and a linear change in the rotation speed of the complex unit vector over the frequency ramps is used, which corresponds to the, if necessary, simplifying assumption of a constant speed of the defined radial relative movement during the acquisition of the I·K scanning values, that is to say corresponds for example to a constant vehicle's ego speed.

Alternatively, the center frequency and time interval of the frequency ramps can also change at least approximately linearly, wherein the relative change in the time interval is, in terms of amount, at least approximately twice as large as the relative change in the center frequency, and the algebraic signs of these changes are opposite, and a linear change in the rotation speed of the complex unit vector over the frequency ramps is used, which corresponds to the, if necessary, simplifying assumption of a constant speed of the defined radial relative movement during the acquisition of the I·K scanning values, that is to say corresponds for example to a constant vehicle's ego speed.

The phase of the complex unit vector may be point-symmetric both over the I scanning values and over the K frequency ramps, that is to say equal to zero in the center in each case, so that no change occurs in the position of the power peaks generated by objects in the two-dimensional discrete time-frequency transformation.

The first stage of the two-dimensional discrete time-frequency transformation can be expediently performed over the I scanning values respectively for each frequency ramp, for example with a fast Fourier transform for efficient realization of the discrete Fourier transform, and the frequency shift can be realized in combination with the window function used for the transformation.

According to a configuration, the window function can be changed iteratively from frequency ramp to frequency ramp by multiplication by the same constantly rotating complex unit vector respectively.

Furthermore, multiple two-dimensional discrete time-frequency transformations with frequency shifts corresponding to different radial relative movements can be calculated over at least partially identical scanning values.

Preferably dependent on the vehicle movement, the preprocessing of the I·K scanning values may include a phase shift of the signal formed from the I scanning values of the respective frequency ramp such that the phase of the signals formed by the I scanning values respectively over the K frequency ramps has a purely linear change for objects with a defined radial relative movement, as a result of which blurring or fuzziness of the power peaks generated by such objects is prevented in the two-dimensional time-frequency transformation in the dimension generated by the K frequency ramps.

The method may be utilized in the case of a radar system, the detection range of which includes the direction of travel, wherein the defined radial relative movement is the negative of the vehicle's ego movement, so that the phase of the signals formed by the I scanning values respectively over the K frequency ramps has a purely linear change for stationary objects in the direction of travel.

Furthermore, the phase shift can be realized by multiplication by a rotating complex unit vector.

A combined realization of the phase shift with the window function which is used in the transformation for the dimension generated by the K frequency ramps can be expedient.

In addition, in an alternative, a radar system for detecting the environment of a motor vehicle, which focuses the radar detection for a relative movement, on the basis of a method is disclosed. The radar system has transmission means for emitting transmission signals in a directed manner, reception means for receiving transmission signals reflected by objects in a directed manner, and signal processing means for processing the received signals, wherein the frequency of the emitted transmission signals is modulated such that it includes a sequence of K linear ramps with at least approximately the same gradient and duration (frequency ramps), in the signal processing means, a signal with substantially the current transmission frequency or a constant offset thereto is mixed with the transmission signals reflected by objects and received by the reception means, in the signal processing means, the output signal of the mixture is, if necessary after suitable preprocessing, scanned I times during each of the K frequency ramps and, in the signal processing means, after preprocessing, a two-dimensional discrete time-frequency transformation over these I·K scanning values is completely or only partially determined. Furthermore, the radar system is characterized in that, dependent on the vehicle movement, the preprocessing of the I·K scanning values includes a frequency shift of the signal formed from the I scanning values of the respective frequency ramp such that the frequency of the signals formed by the I scanning values respectively remains unchanged over the K frequency ramps for objects with a defined radial relative movement, as a result of which fuzziness/blurring, that is to say a kind of expansion, of the power peaks generated by such objects is counteracted in the two-dimensional time-frequency transformation.

### DESCRIPTION OF THE DRAWINGS

In FIG. 1, the exemplary embodiment of a radar system is depicted.

FIG. 2 shows the frequency of the transmission signals which represent so-called frequency ramps having a constant frequency position.

FIG. 3 shows the magnitude spectrum after the two-dimensional discrete Fourier transform for four objects without utilizing the method, wherein the objects have no relative acceleration to the radar system.

FIG. 4 shows the magnitude spectrum after the two-dimensional discrete Fourier transform for four objects utilizing the method, wherein the objects have no relative acceleration to the radar system.

FIG. 5 shows the magnitude spectrum after the two-dimensional discrete Fourier transform for four objects which have a relative acceleration to the radar system, wherein only the first step of the method is utilized, that is to say only one frequency shift of the received signals.

FIG. 6 shows the magnitude spectrum after the two-dimensional discrete Fourier transform for four objects which have a relative acceleration to the radar system, wherein both steps of the method are utilized, that is to say both frequency and phase shift of the received signals.

In FIG. 7, the frequency of the transmission signals having a linearly changing frequency position is depicted.

### DETAILED DESCRIPTION

The exemplary embodiment of a radar system, which is roughly depicted in FIG. 1, is considered. The radar system has one transmitting antenna TX0 for emitting transmission signals and M=4 receiving antennas RX0-RX3 for receiving transmission signals reflected by objects; the antennas are embodied as patch antennas on a planar board 1.1 in planar technology, wherein this board is oriented with respect to the horizontal and vertical direction in the vehicle as depicted in the figure, and looks in the direction of travel. All of the antennas (transmitting and receiving antennas) each have the same emission characteristic in elevation and azimuth. The 4 receiving antennas (and therefore their phase centers, that is to say emission centers) each have the same lateral, i.e., horizontal spacing d=λ/2=1.96 mm with respect to one another, wherein λ=c/76.5 GHz=3.92 mm is the mean wavelength of the emitted signals in the frequency band utilized, 76-77 GHz, and c=3*108 m/s is the speed of light.

The transmission signals emitted at the transmitting antenna are obtained from the high-frequency oscillator 1.2 in the 76-77 GHz range, which can be changed in its frequency via a control voltage v_{control}. The control voltage is generated in the control means 1.7, wherein these control means contain, e.g., a phase-locked loop or a digital/analog converter, which are driven so that the frequency profile of the oscillator corresponds to the desired frequency modulation.

The signals received by the four receiving antennas are likewise mixed down in parallel in the real-valued mixers 1.3 with the signal of the oscillator 1.2 into the low-frequency range. The received signals then pass through the bandpass filters 1.4 having the depicted transfer function, the amplifiers 1.5 and the analog/digital converters 1.6. They are subsequently further processed in the digital signal processing unit 1.8.

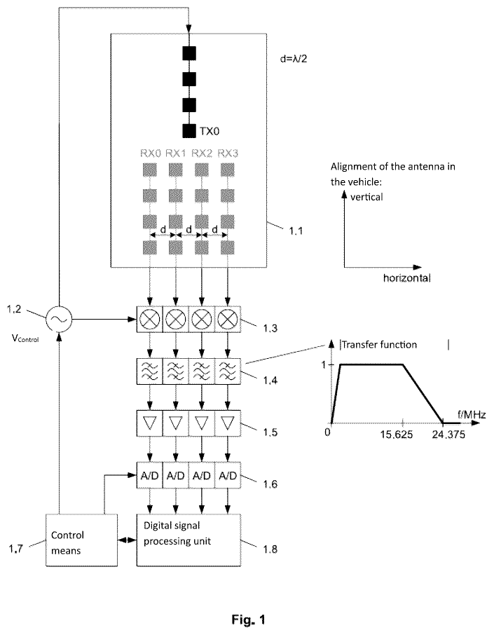

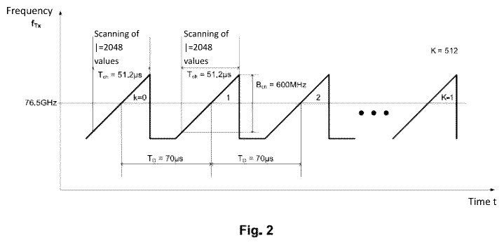

To be able to measure the distance of objects, the frequency f_{TX} of the high-frequency oscillator and, therefore, of the transmission signals is—as depicted in FIG. 2—changed linearly very rapidly (by B_{ch}=600 MHz in T_{ch}=51.2 μs, wherein the center frequency f_{c} amounts to 76.5 GHz); this is referred to as a frequency ramp (frequently also referred to as a “chirp”). The frequency ramps are repeated periodically T_{Dc}=70 μs in the fixed grid; overall, there are K=512 frequency ramps which all have the same frequency profile, i.e., the same frequency gradient, the same frequency position (that is to say, for example the same start and center frequency) and the same duration. In recent years, this type of modulation has become increasingly widespread and generally accepted in radars for detecting the environment of motor vehicles. It allows a high sensor range and speed resolution (due to a long data acquisition time) as well as a high distance resolution (due to the use of a high modulation bandwidth).

During each frequency ramp k=0, . . . , K-1, the received signals are scanned I=2048 times by each of the M=4 A/D converters m=0, . . . , M-1 in each case at intervals of Tₛ=25 ns (that is to say, with 40 MHz), wherein the scanning always begins at the same point in time relative to the start of the ramp (see FIG. 2); the resulting digital scanned values having index i=0, . . . , I-1 are denoted by s(i,k,m). A signal scanning only makes sense in the time domain in which received signals from objects arrive in the distance range of interest—that is to say that, following the ramp start, it is necessary to wait for at least the propagation time corresponding to the distance of maximum interest (in the case of a distance of maximum interest of 200 m, this corresponds to 1.33 μs); it should be pointed out that, here and below, distance is always understood to mean the radial distance, and relative speed is always understood to mean its radial component.

As is known from the prior art and can also be derived in a simple manner, in the case of an individual point-shaped object at a spacing r(k), the scanning signal s(i,k,m) represents a sinusoidal oscillation over the index i which in a very good approximation can be described as follows:

$$s ( i , k , m ) = A ( m ) / ( r ( k ) / ( Meter ) ) \hat{} 2 \cdot sin ( 2 π \cdot i / I \cdot r ( k ) / ( Meter ) \cdot {B}_{ch} / 150 MHz + φ ( k ) + {φ}_{0} ( m ) ) , \qquad ( 1 )$$

i.e., the frequency of the oscillation is proportional to the object distance r(k), which changes slightly in the case of a radial relative movement of the object towards the sensor over the K=512 frequency ramps k=0, . . . , K-1. A relative movement also has an effect in the phase position φ(k) of the sinusoidal oscillation; in the case of a movement having a constant radial speed component v, the result is:

$$φ ( k ) = 2 π \cdot k \cdot 2 {T}_{DV} {f}_{c} / c , \qquad ( 2 )$$

i.e., the phase position changes linearly over the frequency ramps k, wherein the rate of change in the phase is proportional to the radial relative speed v of the object. Due to the linearity of the receivers, the scanning signal s(i,k,m) results in the case of multiple and/or extended objects as a linear superposition of sinusoidal functions of the above form.

If the change in the object distance r(k) is neglected in relationship (1), that is to say a constant frequency is assumed for all of the frequency ramps, then the optimal filtering of the signal form (1) for each receiving channel m corresponds to a two-dimensional discrete Fourier transform (DFT), which can be realized very efficiently in two stages over two one-dimensional fast Fourier transforms (FFT). This, including suitable signal windowing (in both dimensions), has been generally accepted as a standard evaluation method for the modulation form according to FIG. 2 considered here.

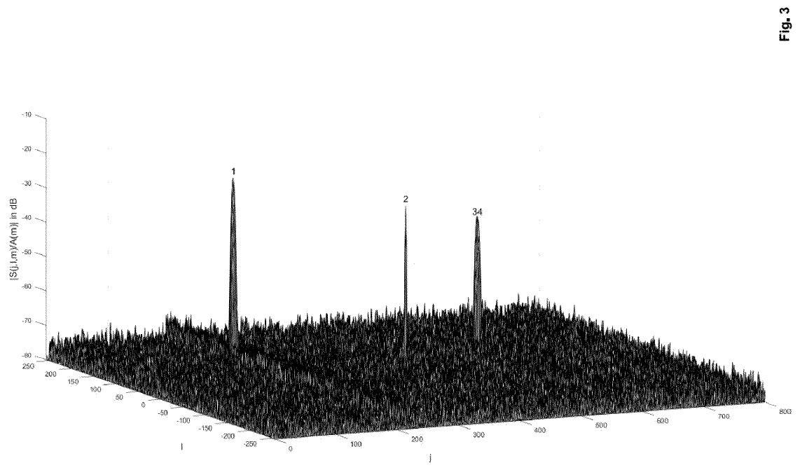

After said two-dimensional DFT, power peaks occur in the resulting spectrum S(j,l,m), the respective position of which corresponds to the mean distance r and relative speed v of the associated object—see FIG. 3, which shows the magnitude spectrum |S(j,l,m)/A(m)| independent of the receiving channel m in dB for four point-shaped objects having the same radar cross-section, azimuth angle of approximately 0° and with the following distances and relative speeds: [r₁=50 m, v₁=−50 m/s], [r₂=100 m, v₂=0 m/s], [r₃=149.25 m, v₃=−50 m/s] and [r₄=150 m, v₄=−50 m/s]; receiver noise, which significantly lies below the power peaks of the objects which are characterized with the object numbers in the spectrum, is additionally superimposed on the signals of the objects. Negative relative speeds mean approaching objects relative to the vehicle; the ego speed of the vehicle is assumed to be 50 m/s so that objects 1, 3 and 4 are stationary. The moving object 2 has no relative speed, that is to say is driving at 50 m/s in absolute terms. The dimension j=0, . . . , J-1 resulting from the dimension i (scanned value indices) is referred to by distance gates and the dimension I=−L/2, . . . L/2-1 resulting from the dimension k (frequency ramps) is referred to by Doppler gates, since the position of the power peaks in dimension j substantially results from the object distance and in dimension I from the radial relative speed (which is illustrated via the Doppler effect)—here, it can be neglected that the power peak position also has a very small dependence, in each case, on the other of the two physical quantities, distance and relative speed. It should be pointed out that the speed cannot be calculated unequivocally from the Doppler gate of the power peak, since in the case of the design presented here only an unambiguous range of 28 m/s is realized over the K=L=256 Doppler gates—ambiguities can be realized, e.g., by varying the spacing T_{D} of the frequency ramps from radar cycle to radar cycle (see also below). According to FIG. 3, the number of the distance gates is only J=801 and therefore significantly smaller than the number I=2048 of the scanned values; the background is that, on the one hand, the scanned values are real-valued, so that their spectrum is symmetrical, i.e., no additional information is included in the upper half of their DFT and, on the other hand, the upper transition range of the analog bandpass filter 1.4 according to FIG. 1 has a frequency bandwidth of 8.75 MHz (corresponds to the range of 448 frequency interpolation points of the DFT). In the case of the modulation bandwidth used here, B_{ch}=600 MHz, the distance gate width 150 MHz/B_{ch}·1 m is precisely 1 m, so that the J=801 distance gates allow a maximum range of 200 m.

As is obvious from FIG. 3, the two stationary objects 3 and 4 with [r₃=149.25 m, v₃=−50 m/s] and [r₄=150 m, v₄=−50 m/s] could not be separated, but are fused in one power peak, although their spacing is three times the distance gate width, which would give reason to expect a separation capability (typically, a difference of two distance gates is needed, for instance, to separate two equally strong point targets). The reason for this can be seen by comparing the stationary object 1 with [r₁=50 m, v₁=−50 m/s] and the moving object 2 with [r₂=100 m, v₂=0 m/s]: the power peak in the case of the moving object with the relative speed zero has the expected sharp form, whilst in the case of the stationary object with high relative speed it is greatly broadened—this broadening of the power peaks leads, in the case of the stationary objects 3 and 4, to their fusion. The broadening is explained by the fact that at a relative speed of −50 m/s, the object wanders relatively by approximately 1.79 m during the entire data acquisition time 512·70 μs=35.84 ms, that is to say, through more than 7 distance gates. Not only does the broadening take place in the distance dimension, but also in the Doppler dimension, because the object is not located in one distance gate the entire time, but rather only for a reduced time, which can be conceived of as a Doppler windowing with a window of reduced width—the spectrum of such a window is broadened and therefore also the form of the power peak, which does of course correspond to this spectrum. In addition to the reduced object separation capability, broadening the power peak also has two further disadvantages: firstly, the possible detection range is reduced (since the level becomes lower because energy dissipates) and, secondly, the measurement of the distance and relative speed becomes less accurate (since noise superimposed on a blurry power peak causes greater errors). It can be seen from this example according to FIG. 3 that limits are placed on a simultaneous high resolution (and, therefore, separation capability) in distance and relative speed during the relative movement of the object to be measured.

The two-dimensional DFT used neglects the fact that in relationship (1) the frequency of the received signal changes slightly over the frequency ramps with the object distance r(k); it therefore deviates all the more from an optimal filtering, the higher the relative speed of the object is. If a constant relative speed v is assumed (which is, for the most part, a permissible simplification during the short data acquisition time), then the object distance changes from frequency ramp to frequency ramp by v·T_{D} (T_{D}=70 μs is the spacing between the frequency ramps) and, therefore according to relationship (1), the time-discrete frequency (based on the scanning value index i, that is to say not based on the continuous time t) by:

$$Δ f = 1 / I \cdot ( v \cdot {T}_{D} ) / ( Meter ) \cdot {B}_{ch} / 150 MHz . \qquad ( 3 )$$

This change Δf in the time-discrete frequency of the received signal from frequency ramp to frequency ramp can be compensated for by a corresponding inverse frequency shift, i.e., the frequency of the received signal of the kth frequency ramp k=0, . . . , K-1 is shifted by the frequency −k·Δf with respect to the frequency of the received signal of the first frequency ramp k=0, which can be realized according to the frequency shift theorem of the Fourier transform by multiplication in the time domain (that is to say over the I scanning values having index i=0, . . . , 1-1 of the respective frequency ramp k) by a rotating complex unit vector:

$${p}_{1} ( i , k ) = exp ( - {i}_{∼} \cdot 2 π \cdot i \cdot k \cdot Δ f ) \qquad ( 4 )$$

(where “exp” denotes the exponential function and the symbol {tilde under (i)} denotes the imaginary unit—not to be confused with the control variable i for the scanning values); the rotation speed of the complex unit vector, which is constant within a frequency ramp, increases linearly over the frequency ramps. After multiplying the scanning values s(i,k,m) by the complex unit vector p₁(i,k) according to relationship (4) using the frequency change Δf according to relationship (3), objects with the radial relative speed v have the same receiving frequency in all frequency ramps so that their power peak is sharp, i.e., focused, in the two-dimensional spectrum.

The ramp index k is defined unsymmetrically (it starts at zero, that is to say it does not equal zero for the “mean” frequency ramp); therefore, in the case of frequency shifting with the rotating complex unit vector p₁(i,k) according to relationship (4), the receiving frequency of each frequency ramp is shifted to that of the first frequency ramp, so that the result of the distance measurement would be the distance at the first frequency ramp, that is to say at the start of the data acquisition. However, the intention would typically be to determine the distance in the center of the data acquisition, which can be attained by replacing k with a (point-) symmetric k-(K-1)/2 (is zero for “mean” frequency ramp (K-1)/2). The index i of the scanning values is also defined unsymmetrically; therefore, according to relationship (4), the complex unit vector p₁(i,k) has a linearly changing phase at the “mean” index (1-1)/2 over the frequency ramps k, which would lead to a slight Doppler shift, that is to say a slightly distorted measurement of the relative speed; to avoid this, i is replaced by a (point-)symmetric i-(I-1)/2. The rotating complex unit vector p₁(i,k) for the frequency shift results as follows:

$${p}_{1} ( i , k ) = exp ( - {i}_{∼} \cdot 2 π \cdot ( i - ( I - 1 ) / 2 ) \cdot ( k - ( K - 1 ) / 2 ) \cdot Δ f ) \qquad ( 5 )$$

with the frequency change Δf according to relationship (3).

A relative speed v has to be defined for this Δf, i.e., the broadening of the power peaks in the two-dimensional DFT can only be completely avoided for a relative speed v of objects; for objects with a different relative speed, the broadening will be all the more pronounced the further their relative speed is from the relative speed defined for the design of Δf.

For the sensor looking in the direction of travel considered here, the accurate recognition of stationary objects is essential, for example in terms of autonomous braking functions. The vehicle must not be braked erroneously, which could happen, e.g., as a result of two stationary objects (stationary vehicles, guardrail posts, buildings, etc.) to the right and left of the ego lane being fused and, as a result, being assumed to be in the ego lane. In this context, it is important to understand that the capability of radar systems to simply separate angles is very poor; in the case of the radar system depicted here which has only one transmitting antenna and 4 receiving antennas, this is only possible—if at all—if the two objects have a very large angular difference. Even those radar systems available today which have significantly more transmitting and receiving antennas can, for the most part, only separate two objects if they have a significant angular difference and a very similar backscatter cross-section. Thus, very good separation capability over distance and/or Doppler has to be relied on (Doppler separation capability also helps in the case of stationary targets, because the radial relative speed depends on the cosine of the azimuth angle); if there is only one object in a distance Doppler cell, the determination of angles is generally accurate enough. In addition to the erroneous braking described above, failing to see real stationary obstacles is of course also critical, e.g. a stationary vehicle next to a guardrail or under a bridge; here as well, good separation capability over distance and/or Doppler is important in order to be able to determine the azimuth angle and, therefore, the position relative to the ego lane accurately enough. Thus, the effect of fuzziness/blurring of the power peaks of stationary objects described above is very disadvantageous in both the distance and Doppler dimensions. Thus, the sensor looking in the direction of travel considered here selects the relative speed v for the design of Δf and, therefore, the rotation speeds of the rotating complex unit vector p₁(i, k) as that of stationary targets at an azimuth angle of 0°, i.e., as the negative of the vehicle's ego speed v_{ego}; the following is obtained from relationship (3):

$$Δ f = 1 / I \cdot ( - {v}_{ego} \cdot {T}_{D} ) / ( Meter ) \cdot {B}_{ch} / 150 MHz . \qquad ( 6 )$$

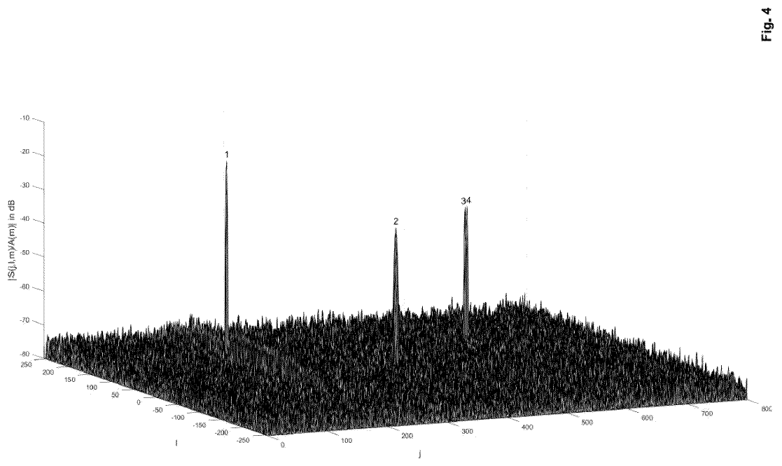

If the frequency shift defined in this way is applied to the above example with the 4 objects, i.e., the scanning values s(i,k,m) are multiplied by the complex unit vector p₁(i,k) according to relationship (5) using the frequency change Δf according to relationship (6), the magnitude spectrum |S(j,l,m)/A(m)| in dB according to FIG. 4 is obtained after the subsequent two-dimensional DFT. All three stationary objects 1, 3 and 4 now show sharp power peaks, so that the two objects 3 and 4 can also be clearly separated with only a 0.75 m difference in distance. The level of the power peaks of these objects has also increased by almost 6 dB (because the power is now focused in a sharp peak).

However, the power peak of the moving object 2 is now broadened and the level has decreased by almost 6 dB (which leads to a reduced detection range). In the original spectrum according to FIG. 3, no frequency shift was performed, i.e., the focus was effectively on the relative speed of zero—and object 2 does of course have precisely a relative speed of zero; with the focus on relative speed −V_{ego} in the spectrum according to FIG. 4, the relative speed of object 2 is now v_{ego} away from it, which leads to the same expansion for the moving object as for the stationary objects in the original spectrum according to FIG. 3. However, from a functional point of view, this is less critical for the forward-facing sensor, because for moving objects, on the one hand, an optimal separation capability in distance and Doppler is less important (multiple moving objects with very similar distances and relative speeds rarely occur) and, on the other hand, a large detection range is not required for an object traveling at the same speed (which is the case for object 2). If, however, a focused power peak is still wanted for the moving object 2, a second two-dimensional DFT would have to be calculated—in this case, the multiplication for the frequency shift would be omitted (since the frequency shift is zero because the relative speed is zero). In the general case, if the intention is to focus on multiple relative speeds, both the multiplication for the frequency shift and the two-dimensional DFT must be calculated multiple times; the spectrum where the relative speed of the object is closest to the relative speed, which was focused on, is then used in each case for one object.

Up to now, the case has been considered that the relative speed v considered for focusing the power peaks is constant, or can be assumed to be, during the data acquisition time. This assumption would lead to blurry power peaks, for example in the case of high relative accelerations and longer data acquisition times. The change Δf in the time-discrete frequency of the received signal from frequency ramp to frequency ramp is then no longer constant (as in relationship (3)), but changes over the frequency ramps k=0, . . . , K-1 as the relative speed v(k) changes:

$$Δ f ( k ) = 1 / I \cdot ( v ( k ) \cdot {T}_{D} ) / ( Meter ) \cdot {B}_{ch} / 150 MHz . \qquad ( 7 )$$

For the rotating complex unit vector p₁(i,k) for the frequency shift, the sum over Δf(k) is required; to this end, the sum of the change in distance v(k)·T_{D} included in the above formula must be calculated. The sum of the time-discrete values v(k)·T_{D} (T_{D} is the spacing between the time-discrete values) corresponds to the integral int[v(t)](k) over the time-continuous v(t) during the transition into the time-continuous at the points of time t(k) belonging to the frequency ramps; e.g., the center of the data acquisition time can be utilized as the reference point of the integration. The rotating complex unit vector p₁(i,k) results as follows:

$${p}_{1} ( i , k ) = exp ( - {i}_{∼} \cdot 2 π \cdot ( i - ( I - 1 ) / 2 ) / I \cdot int [ v ( t ) ] ( k ) / ( Meter ) \cdot {B}_{ch} / 150 MHz ) ; \qquad ( 8 )$$

It should be pointed out that, in this relationship, it is furthermore assumed that the relative speed is constant during a ramp, which is expressed by a constant rotation speed of p₁(i,k) during each frequency ramp (this assumption is also valid at high relative acceleration, because of the very short time of the frequency ramps).

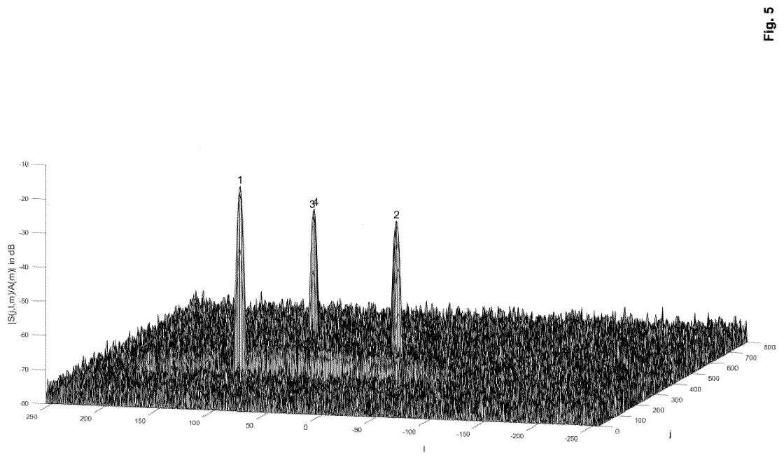

After multiplying the scanning values s(i,k,m) by the unit vector p₁(i,k), all of the frequency ramps have the same receiving frequency, so that no broadening of the power peaks occurs in the spectrum in the distance dimension. However, it must also be taken into account that the relative speed changes with a relative acceleration, which means that multiple Doppler gates can be roamed over the data acquisition time and, in this way, a broadening of the power peaks can still occur in the Doppler dimension; FIG. 5 shows this effect for the four objects above in the case of an additional relative acceleration of 10 m/s² (due to full braking of the ego vehicle). A changing relative speed means that the phase φ(k) of the received signals no longer changes linearly over the frequency ramps, so that relationship (2) is no longer valid; the change is now proportional to the non-constant relative speed, and therefore the term k·T_{D}·v in relationship (2) must be replaced by the integral int[v(t)](k) (similar to the above derivation for p₁(i,k) according to relationship (8)):

$$φ ( k ) = 2 π \cdot int [ v ( t ) ] ( k ) \cdot {f}_{c} / c . \qquad ( 9 )$$

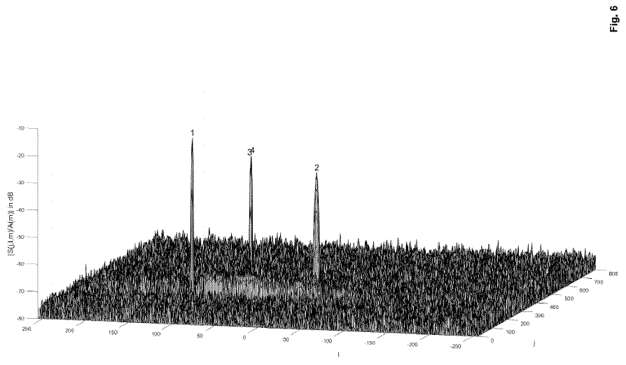

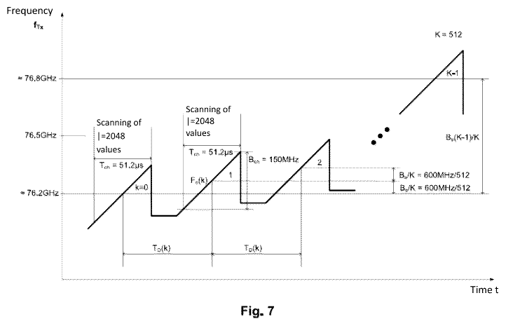

The nonlinear component in the phase φ(k) results from the difference between this relationship (8) and the original relationship (2), and can be compensated for by multiplying the scanning values s(i,k,m) by a corresponding second complex unit vector p₂(k) which changes from frequency ramp to frequency ramp, but is constant for each frequency ramp:

$${p}_{2} ( k ) = exp ( - {i}_{∼} \cdot 2 π \cdot ( int [ v ( t ) ] ( k ) - k \cdot {T}_{D} \cdot {v}_{av} ) \cdot {f}_{c} / c ) , \qquad ( 10 )$$

wherein vₐᵥ is the mean speed during the data acquisition time. FIG. 6 shows the magnitude spectrum |S(j,l,m)/A(m)| when applying this second complex unit vector p₂(k) to the relative acceleration 10 m/s²; the stationary objects now have sharp power peaks again (it should be pointed out that the two objects 3 and 4 are separated in the distance dimension in both FIG. 5 and FIG. 6, which is not obvious due to the viewing angle).

After multiplying the scanning values s(i,k,m) by both complex unit vectors p₁(i,k) and p₂(k), a sharp power peak is obtained in the spectrum in both dimensions (that is to say, distance and Doppler), provided that the object has the relative movement which forms the basis of the design of p₁(i,k) and p₂(k). As explained above, for the forward-looking sensor considered here, the stationary objects around azimuth 0° are most important, so that the relative movement to be considered is the inverse, that is to say, the negative of the generally non-constant ego movement v_{ego}(t); the two complex unit vectors p₁(i,k) and p₂(k) result as follows:

$${p}_{1} ( i , k ) = exp ( {i}_{∼} \cdot 2 π \cdot ( i - ( I - 1 ) / 2 ) / I \cdot int [ {v}_{ego} ( t ) ] ( k ) / ( Meter ) \cdot {B}_{ch} / 150 MHz , \qquad ( 11 a )$$

$${p}_{2} ( k ) = exp ( {i}_{∼} \cdot 2 π \cdot ( int [ {v}_{ego} ( t ) ] ( k ) - k \cdot {T}_{D} \cdot {v}_{ego , av} ) \cdot {f}_{c} / c ) . \qquad ( 11 b )$$

It should be pointed out that, in relationship (11b), the subtraction of k·T_{D}·v_{ego,av} could in principle also be omitted; this would mean a Doppler shift such that stationary objects at azimuth 0° come to lie at Doppler 0.

As an alternative to the modulation form according to FIG. 1, the modulation form depicted in FIG. 7 can be used, in which the individual frequency ramps have a bandwidth reduced to 25% B_{ch}=150 MHz, but their frequency position (e.g., characterized by their center frequency) is increased linearly over the frequency ramps over the bandwidth Bₛ=600 MHz. In the Doppler dimension of the two-dimensional DFT, this linear change in the center frequency leads to a distance-dependent component over which a high distance resolution corresponding to the modulation bandwidth Bₛ=600 MHz is realized. For relatively moving objects, a strong expansion of the power peak in the Doppler dimension can be counteracted by a linearly changing time interval T_{D}(k) of the frequency ramps k=0, . . . , K-1; relatively speaking, this change is, in terms of amount, twice as large as the change in the center frequency and has the opposite algebraic sign, that is to say for the example in FIG. 2 it is −2·600 MHz/76.5 GHz=−1.57% (decrease by 1.57% over the K frequency ramps). Admittedly, in the case of this form of modulation, there is also the effect that the receiving frequency changes slightly over the frequency ramps due to relative movement; however, since the individual frequency ramps have a significantly smaller bandwidth B_{ch}=150 MHz than for the first form of modulation, the effect of the blurring/fuzziness of the power peaks in the distance and Doppler dimensions is significantly smaller (by a factor of 4). However, this smaller effect can also be completely eliminated as above by shifting the frequency, that is to say by multiplying the scanning values by the complex unit vector p₁(i,k) according to the above formulas. The effect of a non-constant relative speed, that is to say a relative acceleration, can be compensated for again by way of additional multiplication by the second vector p₂(k) according to the above formulas. The above relationships were at least partially derived assuming temporally equidistant frequency ramps, which is not exactly the case here—however, the deviation from this assumption is negligibly small.

The determination of the two-dimensional DFT is, for the most part, realized first with a FFT for the distance dimension and then with an FFT for the Doppler dimension. The reason for this is that the data from the frequency ramps arise one after the other and—as soon as data from a new frequency ramp is available—this first FTT can then be determined using the scanning values of the respective frequency ramp. In addition, after this first FFT for the distance dimension, the resulting data can be highly compressed without significant loss of information (see EP 3 152 587 B1). The FFT for the Doppler dimension can only be determined once the data over all frequency ramps are available (that is to say, after the entire data acquisition); that is to say that if the starting point were to be the FFT for the Doppler dimension, the determination of the two-dimensional DFT could only be started after the entire data acquisition. If the FFT for the distance dimension, that is to say over the dimension i of the scanning values s(i,k,m) is determined first of all, then it is only necessary to multiply by the component of the complex unit vectors which depends on dimension i, that is to say by p₁(i,k)-p₂(k) does not depend on dimension i and can therefore also be multiplied after the first FFT. It may be helpful to first form the product between the window function of the first FTT (for the distance dimension) and the vector p₁(i,k) once and to apply the window function modified in this way to the received signals of all M=4 receiving antennas. In the case of a relative speed which is assumed to be constant, that is to say for a p₁(i,k) according to relationship (5), it can for example be helpful when using hardware-accelerated computing units, if this modified window function is iteratively produced over the frequency ramps k by multiplication by the k-independent vector exp(−{tilde under (i)}·2π·(i−(I-1)/2)·Δf) (this is also a rotating complex unit vector). It should be pointed out that after multiplying the real-valued scanning values s(i,k,m)) by the complex unit vector p₁(i,k) a complex-valued signal is created, so that the potential of a real-valued input signal may no longer be utilized with the FFT. As already mentioned above, the multiplication by the complex unit vector p₂(k) which only depends on the frequency ramp control variable k can only be carried out after the first FFT, which is expediently realized by multiplying vector p₂(k) once by the window function of the second FFT (for the Doppler dimension); this modified window function can then be used for the signals to all M=4 receiving antennas and all J=801 distance gates.

It should be stressed that the method is not restricted to the above sequence for realizing the two-dimensional DFT. It is also possible to start with the FFT for the Doppler dimension, wherein the multiplication by both complex unit vectors p₁(i,k) and p₂(k) may then be realized first, since both have a dependence on the frequency ramp control variable k.

Up to now, a forward-facing sensor has been considered. Of course, the method can also be utilized for sensors having a different orientation. However, the relative movement used as the basis for the design of the complex unit vectors p₁(i,k) and p₂(k) will then, if necessary, be defined differently; for a rear-facing sensor, it is not the stationary objects which are of the highest importance, but rather rapidly approaching vehicles.

To ensure that the radar system is robust in respect of interference from other radar systems, parameters of the modulation may be varied, for example.:
mean spacing between the frequency ramps from cycle to cycle (as explained above, additionally allows speed ambiguities to be resolved easily);
modulation bandwidth B_{ch} (amount and/or algebraic sign) from cycle to cycle;
time interval T_{D}(k) of the frequency ramps by superimposition of a random or pseudo-random, mean value-free component varying over k, typically in the range of up to a few microseconds; for relatively moving objects, the reception phase then has a component which varies slightly over the frequency ramps, but which is still so small that the effects produced as a result after the DFT (noise and level reduction of the peak power) are negligible;
frequency position of the frequency ramps (that is to say, their center frequency) by superimposition of a random or pseudo-random mean value-free component varying over k; this variation in the frequency position can also be realized by always utilizing the same frequency ramps, but varying the point in time as of which the scanned values of the received signal are obtained; the resulting phase variation of the received signals, which is proportional to the distance gate, can be compensated for by a corresponding general phase correction after the first one-dimensional DFT for distance dimension;
phase position of the individual transmission signals by an additional phase modulator in the transmission means, wherein the phase position is varied randomly or pseudo-randomly over the frequency ramps, which is preferably to be compensated again on the receiving side in the digital signal processing means.

In the radar system considered according to FIG. 1, there are M=4 receiving antennas and associated receiving channels m=0, . . . , M-1. After the two-dimensional DFT, a digital beam shaping, e.g., is also preferably calculated again in the form of a DFT or FFT in each distance/Doppler gate (j, I); that is to say, a three-dimensional Fourier transform is performed. Power peaks are then determined in the three-dimensional spectrum. The azimuth angle of an object results from the position of its power peak in the third dimension which is created from the dimension m of the receiving channels; according to the above interrelations, the distance and relative speed result from the other two dimensions. In order to have more channels available for the angle formation, not only may multiple receiving antennas utilized, but also multiple transmitting antennas, and the signals of all combinations of transmitting and receiving antennas may be evaluated in order to realize many virtual receiving channels. If all or some of the transmitting and/or receiving antennas are not operated simultaneously, then multiple for example identical sequences of frequency ramps of the types described above are nested within one another.

It should be pointed out that the considerations and explanations presented on the basis of the above exemplary embodiment can of course be transferred in a simple manner to general measurements and parameter designs, i.e., they can also be applied to other numerical values. Thus, general parameters are also indicated in formulas and figures.

1-16. (canceled)

17. A method for detecting the environment of a motor vehicle with a radar system comprising:
modulating a frequency of emitted transmission signals from a transmitter such that the frequency of the signals includes a sequence of frequency ramps;
mixing, in a signal processor, a signal having one of the emitted transmission frequency and a constant offset thereto with transmission signals reflected by objects and received by a receiver to provide an output signal;
scanning, in the signal processor, the output signal of the mixture a number of times during each of the frequency ramps to provide scanning values;
preprocessing the scanning values dependent on the vehicle movement to include a frequency shift of the signal formed from the scanning values of the respective frequency ramp such that the frequency of the signals formed by the scanning values respectively remains unchanged over the frequency ramps for objects with a defined radial relative movement; and
determining at least partially, in the signal processor, a two-dimensional discrete time-frequency transformation over the scanning values, wherein fuzziness of power peaks generated by the objects, is counteracted in the two-dimensional time-frequency transformation.

18. The method according to claim 17, wherein a detection range of the radar system includes the direction of travel and the defined radial relative movement is the negative of the vehicle's ego movement, so that the frequency of the signals formed by the scanning values respectively remains constant over the frequency ramps for stationary objects in the direction of travel.

19. The method according to claim 17, wherein the frequency shift is realized by multiplication by a rotating complex unit vector.

20. The method according to claim 19, wherein the scanning values respectively of the frequency ramps are equidistant in time and the rotation speed of the complex unit vector is constant during each frequency ramp, but changes over the frequency ramps.

21. The method according to claim 20, wherein the rotation speed of the complex unit vector changes over the frequency ramps proportionally to the integral of the speed of the defined radial relative movement.

22. The method according to claim 21, wherein a center frequency and time interval of the frequency ramps are approximately constant and a linear change in the rotation speed of the complex unit vector over the frequency ramps is used, which corresponds to an assumption of a constant speed of the defined radial relative movement during the acquisition of the scanning values.

23. The method according to claim 21, wherein a center frequency and time interval of the frequency ramps change approximately linearly, wherein the relative change of an amount in the time interval is approximately twice as large as the relative change in the center frequency, and the algebraic signs of these changes are opposite, and a linear change in the rotation speed of the complex unit vector over the frequency ramps is used, which corresponds to the, assumption of a constant speed of the defined radial relative movement during the acquisition of the scanning values.

24. The method according to claim 22, wherein a phase of the complex unit vector is point-symmetric over the scanning values and over the frequency ramps, so that no change occurs in the position of the power peaks generated by objects in the two-dimensional discrete time-frequency transformation.

17. The method according to claim 17, wherein a first stage of the two-dimensional discrete time-frequency transformation is performed over the scanning values respectively for each frequency ramp, and the frequency shift is realized in combination with a window function used for the transformation.

25. The method according to claim 25, wherein the time-frequency transformation is a fast Fourier transformation.

27. The method according to claim 22, wherein a window function is changed iteratively from frequency ramp to frequency ramp by multiplication by the same constantly rotating complex unit vector respectively.

28. The method according to claim 17, wherein multiple two-dimensional discrete time-frequency transformations with frequency shifts corresponding to different radial relative movements are calculated over at least partially identical scanning values.

29. The method according to claim 17, wherein, dependent on the vehicle movement, the preprocessing of the scanning values includes a phase shift of the signal formed from the scanning values of the respective frequency ramp such that a phase of the signals formed by the scanning values respectively over the frequency ramps has a linear change for objects with a defined radial relative movement, as a result of which fuzziness of the power peaks generated by such objects is prevented in the two-dimensional time-frequency transformation in the dimension generated by the frequency ramps.

30. The method according to claim 29, wherein a detection range of the radar system includes the direction of travel and the defined radial relative movement is the negative of the vehicle's ego movement, so that the phase of the signals formed by the scanning values respectively over the frequency ramps has a purely linear change for stationary objects in the direction of travel.

31. The method according to claim 29, wherein the phase shift is realized by multiplication by a rotating complex unit vector.

32. The method according to claim 29, wherein a combined realization of the phase shift with the window function is used in the transformation for the dimension generated by the frequency ramps.

33. The method according to claim 17, wherein the frequency ramps are linear ramps with approximately the same gradient and duration.

34. A radar system for detecting the environment of a motor vehicle comprising:
a transmitter for emitting transmission signals in a directed manner, wherein the frequency of the emitted transmission signals is modulated such that it includes a sequence of frequency ramps;
a receiver for receiving transmission signals reflected by objects in a directed manner; and
a signal processor for processing the received signals;
wherein a signal with the current transmission frequency or a constant offset thereto is mixed with the transmission signals reflected by objects and received by the receiver in the signal processor;
wherein the output signal of the mixture is scanned in the signal processor a number of times during each of the frequency ramps;
wherein in the signal processor the scanning values are preprocessed dependent on the vehicle movement to include a frequency shift of the signal formed from the scanning values of the respective frequency ramp such that the frequency of the signals formed by the scanning values respectively remains unchanged over the frequency ramps for objects with a defined radial relative movement; and
wherein in the signal processor, a two-dimensional discrete time-frequency transformation over the scanning values is at least partially determined such that fuzziness of power peaks generated by the objects, is counteracted in the two-dimensional time-frequency transformation.
